(19) United States
(12) Patent Application Publication
(10) Pub. No.: US 2015/0199908 A1
(43) Pub. Date: Jul. 16, 2015

(54) TRANSLATING CONTENT FOR LEARNING A LANGUAGE

(71) Applicant: Google Inc., Mountain View, CA (US)

(72) Inventors: Tristan SMITH, Brooklyn, NY (US); Sandra Nam, New York, NY (US); Anthony Cafaro, New York, NY (US); Robert Wong, New York, NY (US); Kevin Selchow Proudfoot, Lebanon, NJ (US)

(73) Assignee: Google Inc., Mountain View, CA (US)

(21) Appl. No.: 13/763,534

(22) Filed: Feb. 8, 2013

(51) Int. Cl. G09B 5/00

(52) U.S. Cl. CPC G09B 5/00

(57) ABSTRACT

A method for translating content includes translating content from a source language into a target language and identifying a target language proficiency of a user. The method also includes determining and displaying a portion of the translated content corresponding to the identified target language proficiency level. Systems and machine-readable media for translating content are also contemplated.

### BACKGROUND

Learning a new language can be difficult and often takes a lot of effort and time. Language learning techniques are available in which language students learn a new language by studying other subjects such as math or science, or doing daily tasks, using the new language.

### SUMMARY

The subject disclosure relates generally to assisting users to learn a new language, and more particularly to assisting users to learn a new language by translating content.

The subject disclosure relates to a machine-implemented method for translating content for learning a language. The method includes translating content requested by a user from a source language into a target language, identifying a target language proficiency level of the user, and determining a portion of the translated content that corresponds to the identified target language proficiency level. The method also includes providing for display the portion of the translated content that is determined to correspond to the target language proficiency level.

The present disclosure also relates to a system that includes a block of text identification module configured to identify a block of text from content requested by a user and determine whether a size of the identified block of text exceeds a predetermined threshold, and a content translation module configured to translate the identified block of text from a source language into a target language, if the size of the identified block of text exceeds the predetermined threshold. The system also includes a target language proficiency identification module configured to identify a target language proficiency level of the user, a translated content portion determination module configured to determine a portion of the translated block of text that corresponds to the identified target language proficiency level. The system further includes a translated content portion display module configured to provide for display the portion of the translated block of text that is determined to correspond to the target language proficiency level.

The present disclosure further relates to a machine-readable medium comprising instructions stored therein, which when executed by processors, cause the processors to perform operations that include identifying text for translation from content requested by a user, where the identified text is in the source language, and translating the identified text for translation from the source language to the target language. The operations also include identifying a target language proficiency level of the user, where the target language proficiency level is identified based on a user selection, and determining a portion of the translated text that corresponds to the identified target language proficiency level. The operations further include providing for display the portion of the translated text that is determined to correspond to the target language proficiency level with the requested content, receiving a selection of the displayed portion of the translated text from the user, and providing for display the selected portion of the translated text in the source language.

It is understood that other configurations of the subject technology will become readily apparent from the following detailed description, where various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

Certain features of the subject technology are set forth in the appended claims. However, for purpose of explanation, several implementations of the subject technology are set forth in the following figures.

FIG. 1 is a diagram of an example system for translating content for learning a language.

FIG. 2 illustrates a flow diagram of an example process for translating content for learning a language.

FIG. 3 is a diagram conceptually illustrating of an example operation for translating content from a source language to a target language according to the subject technology.

FIG. 4 conceptually illustrates an example of a system for translating content for learning a language.

FIG. 5 conceptually illustrates an electronic system with which some aspects of the subject technology are implemented.

### DETAILED DESCRIPTION

In the following detailed description, numerous specific details are set forth to provide a full understanding of the present disclosure. It will be apparent, however, that the implementations of the present disclosure may be practiced without some of these specific details. In other instances, structures and techniques have not been shown in detail so as not to obscure the disclosure.

Among various techniques for learning a new language, language immersion techniques are available in which language students learn a new language by studying other subjects such as math or science, or doing daily tasks, using the new language.

According to various aspects of the subject technology, a method and system for translating content for learning a language are provided. A language immersion technique is applied to content (e.g., web pages or blog posts) that users may access frequently. Specifically, content is displayed to the user such that it appears to the user that content that is in a source language (e.g., user's native language) is spontaneously translated into a target language (e.g., a new language that the user wishes to learn) according to the user's selected target language proficiency level, when a user accesses the content. At lower proficiency levels, small portions of the content are translated into the target language. Therefore, at the lower target language proficiency levels, large portions of the content remain un-translated (e.g., remain in the source language that the user easily understands), thereby providing sufficient context to the user to be able to figure out the meaning of the translated portions without much help.

As the selected target language proficiency level increases, more portions are translated into the target language. It follows that as more portions are translated into the target language, less portions remain in the source language to provide context to the translated portions. Each target language proficiency level may be associated with a predetermined metric for determining the portions of the translated content for display to the user. For example, a low target language proficiency level may be associated with translating a small number of predetermined commonly-used words, and a high target language proficiency level may be associated with translating a larger number of words, including a predetermined number of less commonly-used words. Therefore, as the user becomes more comfortable with having less context in the source language, the user may increase the target language proficiency level to improve the user's proficiency in the target language.

Specifically, when a user requests content such as blog posts, news articles or web pages that include text in a source language (e.g., user's native language), the system displays portions of the source language text in a target language (e.g., a new language that the user wishes to learn), such that it appears to the user that the portions of the requested content are automatically translated into the target language. The user also selects a proficiency level, according to which the system determines the portions of the source language text to display in the target language. For example, if the user selects a beginner proficiency level, the system may display easy words or short phrases in the target language. For an advanced proficiency level, the system may present full sentences or large blocks of text in the target language.

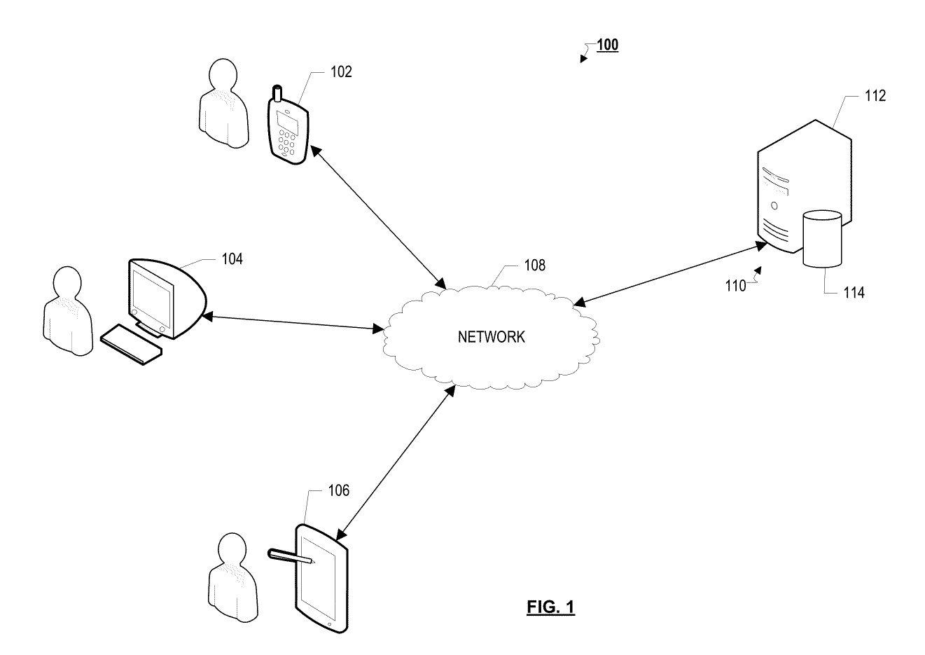

FIG. 1 illustrates an example client-server network that provides for translating content for learning a language. A network display 100 includes a number of electronic devices 102, 104 and 106 communicably connected to a server 110 by a network 108. Server 110 includes a processing device 112 and a data store 114. Processing device 112 executes computer instructions stored in data store 114, for example, instructions for translating content for learning a new language. Such instructions include, for example, translating content requested by a user from a source language into a target language, identifying a target language proficiency level of the user, determining a portion of the translated content that corresponds to the identified target language proficiency level, and providing for display the portion of the translated content that is determined to correspond to the target language proficiency level.

The target language proficiency level may be identified based on a user selection, and the information pertaining to the target language proficiency level may be stored, for example, in data store 114. The different language proficiency levels may be predefined based on a predetermined language proficiency scale. Information pertaining to the language proficiency scale may also be stored, for example, in data store 114. Data store 114 may also store information pertaining to, for example, the source language and the target language.

Server 110 may host an application within which some of the processes discussed herein are implemented. In some example aspects, electronic devices or client devices, as used interchangeably herein, 102, 104 and 106 can be computing devices such as smartphones, PDAs, portable media players, tablet computers, televisions or other displays with one or more processors coupled thereto or embedded therein, or other appropriate computing devices that can be used for running a mobile application (e.g., a mobile application for accessing a social networking site).

Electronic devices 102, 104 and 106 may have one or more processors embedded therein or attached thereto, or other appropriate computing devices that can be used for accessing a host, such as server 110. For example, the server 110 may host content such as web pages or blog posts, and users may access the content using any of the electronic devices 102, 104 or 106 to share and consume shared content. In the example of FIG. 1, electronic device 102 is depicted as a smartphone, electronic device 104 is depicted as a television, and electronic device 106 is depicted as a tablet computer. A client is an application or a system that accesses a service made available by a server which is often (but not always) located on another computer system accessible by a network. Some client applications may be hosted on a website, whereby a browser is a client. Such implementations are within the scope of the subject disclosure, and any reference to client may incorporate a browser and reference to server may incorporate a website.

The system (e.g., hosted at server 110, or any of the electronic devices 102, 104, or 106), translates content that is requested by a server from a source language to a target language. The source language may be, for example, the user's native language, and the target language may be, for example, a new language that the user wishes to learn. The source language and the target language may be predetermined based on user selections. Before translating the requested content into the target language, the system may determine whether the requested content includes text in the source language, and translate the requested content into the target language if the requested content includes text in the source language.

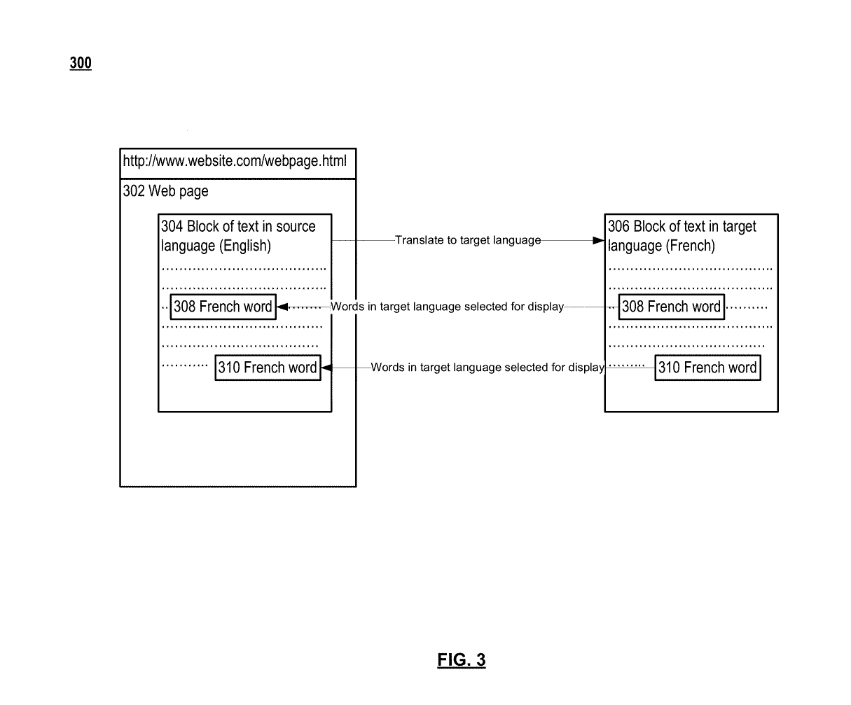

The translated content may not be displayed to the user in its entirety, depending on the target language proficiency level of the user. Rather, the system determines a portion of the translated content for display to the user based on the target language proficiency level. Each target language proficiency level, for example, is associated with a predetermined metric for determining the portions of the translated content for display to the user. For example, the target language proficiency level may be part of a language proficiency scale according to which a small number of predetermined commonly-used target language words are determined for display at the lowest level. As the language proficiency level increases, the predetermined target language words become increasingly less commonly-used words, and the number of target language words determined for display also increases. For the highest level of the language proficiency scale, all of the translated content may be determined for display to the user. Determining the portions of the translated content for display to the user based on the target language proficiency level is discussed in more detail below with reference to FIG. 3.

The portions of the translated content that are determined for display to the user are provided for display to the user with the original content requested by the user. The portions of the translated content that are determined for display to the user and the original requested content may be provided for display such that it appears to the user that only certain words or phrases (e.g., portions of the translated content that are determined for display) of the original requested content (which is in the source language) are spontaneously translated into the target language.

The system may also receive a user selection on the displayed portion of the translated content, and display the selected portion of the translated content back in the source language. For example, after the determined portion of the translated content is displayed to the user, the user may click or otherwise select the displayed portion of the translated content to view the corresponding content in the source language. Specifically, if a word in an English sentence had been translated to and displayed in French, the user may click on the French word to view the word back in English.

In an aspect of the subject technology, when translating the requested content into the target language, the system may first identify, from the requested content, a block of text for translation, instead of translating the entire available text. If the size of the identified block of text is greater than a predetermined threshold, the block of text is selected for translation into the target language. If the size of the block of text is too small, another block is selected. The threshold may be predetermined such that the block of text would provide sufficient context to words within the block that may be translated into the target language. For example, an email body or an article may be selected for translation, whereas a subject line displayed in an email inbox may not be too small for selection for display to the user.

The above descriptions describe the subject technology as first translating the requested content and then selecting a portion of the translated content for display to the user. However, in an aspect of the subject technology, a portion of content for display to the user may be selected before translation, and only the selected portion is translated and displayed to the user.

Each electronic device 102, 104 and 106 may be a client device or a host device. In some example aspects, server 110 can be a single computing device such as a computer server. In other implementations, server 110 can represent more than one computing device working together to perform the actions of a server computer (e.g., cloud computing). The server 110 may host the web server communicationally coupled to the browser at the client device (e.g., electronic devices 102, 104 or 106) via network 108.

The network 108 can include, for example, any one or more of a personal area network (PAN), a local area network (LAN), a campus area network (CAN), a metropolitan area network (MAN), a wide area network (WAN), a broadband network (BBN), the Internet, and the like. Further, the network 108 can include, but is not limited to, any one or more of the following network topologies, including a bus network, a star network, a ring network, a mesh network, a star-bus network, tree or hierarchical network, and the like.

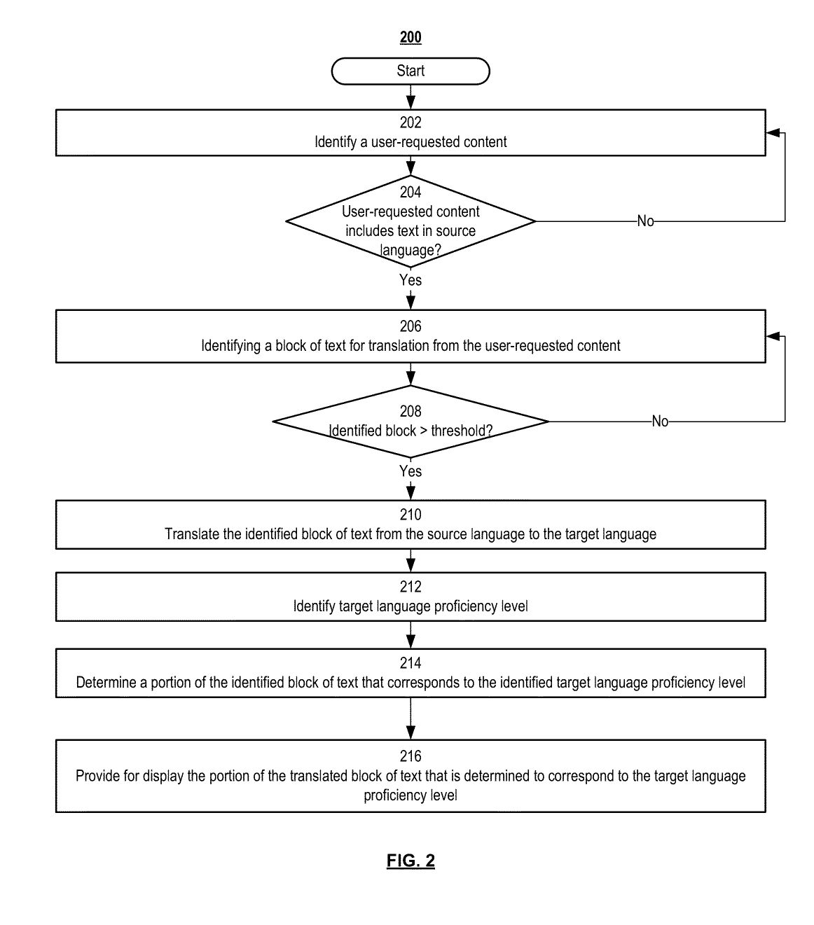

FIG. 2 illustrates a flow diagram of an example process 200 for translating content for learning a language. Process 200 may be performed, for example, by the system discussed above which may be hosted at server 110, or any of the electronic devices 102, 104 or 106 of FIG. 1. Process 200 begins and at block 202, the system identifies a user-requested content. For example, the user may request access to a web page, and the system may identify the web page that the user has requested. At block 204, the system determines whether the user-requested content identified at block 202 includes text that is provided in the source language. The source language may be predetermined based on a user selection. The source language may be, for example, the user's native language. Information pertaining to the predetermined source language may be stored, for example, in data store 114. If the user-requested content is not determined to include text in the source language at block 204, the process reverts to block 202.

If at block 204, the user-requested content is determined to include text in the source language, at block 206, the system identifies, from the user-requested content, a block of text for translation. The user-requested content may include one or more blocks of text which may be logically, or visually, separated from each other. For example, the user-requested content may be a web-based email application. The email application may include a section showing a body of an email, and an inbox section showing subject lines of multiple emails. In such case, the body of an email may be identified as a block of text, and the subject lines of multiple emails in the inbox section may each be identified as a separate blocks of text.

At block 208, the system determines whether the size of the block of text identified at block 206 exceeds a predetermined threshold. If the size of the block of text is determined to exceed the predetermined threshold at block 208, the block of text identified at block 204 is translated, at block 210, from the source language into the target language. The translation may be performed, for example, at server 110, or at a translation server (not shown) that is in communication with the network 108.

If the size of the block of text is determined not to exceed the predetermined threshold at block 208, process 200 reverts to block 206. The threshold may be predetermined such that the block of text that would be translated at block 210 would provide sufficient context to words within the block that may be translated into the target language. In the example above, the threshold may be predetermined such that the email body exceeds the threshold, whereas a subject lines displayed in the inbox may not be too small to exceed the threshold.

At block 212, the system identifies a proficiency level of the target language for the user. The target language proficiency level for the user may be, for example, selected by the user, and information pertaining to the user's selected target language proficiency level may be stored, for example, data store 114. Therefore, the system may access the data store 114 to identify the target language proficiency level for the user. At block 214, the system determines a portion of the block of text translated at block 210 that corresponds to the target language proficiency level identified at block 212. The portion of the translated block of text determined at block 214 may be a single translated word, multiple independent translated words, or words that are part of a translated phrase.

The type of translated words or phrases and the number of translated words or phrases that are determined to correspond to each target language proficiency level at block 214 may be determined based on widely acknowledged language proficiency scales such as, for example, ILR (Interagency Language Roundtable) proficiency ratings developed for the US military, ACTFL (American Council on the Teaching of Foreign Language) scale, or the official ESL (English as a Second Language) scale. Other scales may also be used. Different scales may be used for different target languages. An example language proficiency scale according to the subject technology is discussed with reference to FIG. 3 below.

At block 216, the system provides for display the portion of the translated block of text determined at block 214, to the user. The system displays the determined portion of the translated text with the user-requested content identified at block 202 (which is provided in the source language). The determined portion of the translated text may be displayed such that the determined portion replaces its source-language counterpart in the user-requested content. In other words, it may appear to the user that certain words or phrases in the content that the user has requested are spontaneously translated into the target language. Therefore, the user may be able to determine the meaning of the translated words or phrases (e.g., the portion of translated block of text determined at block 214) based on context provided by text surrounding the translated words or phrases.

FIG. 3 shows a diagram 300 conceptually illustrating an example operation for translating content from a source language to a target language according to the subject technology. A user may request content such as web page 302. Web page 302 may contain block of text 304 which is in a source language. The source language may be, for example, the user's native language. Diagram 300 shows that the source language is English. Diagram 300 also shows that the system has identified block of text 304 for translation from the source language to a target language. The target language may be, for example, a new language that the user wishes to learn. Diagram 300 shows that the target language is French. The system performs the translation on the entire block of text 304 to obtain a counterpart block of text 306, which is in French. The translation may be performed at a translation server (not shown). The translation server may be, for example, hosted at server 110, or may be an independent server in communication with network 108.

From the block of text 306 (which is in French), the system determines specific French words or phrases that correspond to a user-selected proficiency level for French, and selects the determined French words for display o the user. Diagram 300 shows that two French words, French words 308 and 310 are selected for display.

The selected French words 308 and 310 are displayed to the user, with the block of text 304 (which is in English) providing context to the French words. Specifically, the selected French words 308 and 310 are displayed such that it appears to the user that the French words 308 and 310 replace the corresponding English words in the block of text 304. Therefore, the user sees the block of English text with select words translated into French. Because the French words 308 and 310 are displayed within the context of English text, the user may be able to guess the meaning of the French words 308 or 310 easily, even if he or she does not recognize the French words 308 or 310.

In an aspect of the subject technology, a language proficiency scale may be provided, which includes five proficiency levels for a target language. The types of translated words/phrases and the number of translated words/phrases may be determined for the different proficiency levels as follows:

A. Target language proficiency level 1: a) 1000 most common target language words may be displayed; b) no two target language words are displayed in a row, to preserve context; and c) only up to a predetermined number of the same target language words are displayed, and not every common target language word in a given block of source language text.

B. Target language proficiency level 2: a) 2000 most common target language words may be displayed; b) however, this number could be lowered if determination is made that more than a predetermined percentage of words are being displayed in the target language for a given block of source language text.

C. Target language proficiency level 3: a) 5000 most common target language words may be displayed; b) if 50% of the target language words in a sentence are in the 5000 most common target language words, then display the entire sentence in the target language.

D. Target language proficiency level 4: a) 15000 most common target language words may be displayed; b) if 50% of the target language words in a sentence are in the 15000 most common target language words, then display the entire sentence in the target language.

E. Target language proficiency level 5: Display full text in the target language.

Other language proficiency scales including, but not limited to, ILR (Interagency Language Roundtable) proficiency ratings developed for the US military, ACTFL (American Council on the Teaching of Foreign Language) scale, or the official ESL (English as a Second Language) scale, may also be used. Different language proficiency scales may be used for different target languages.

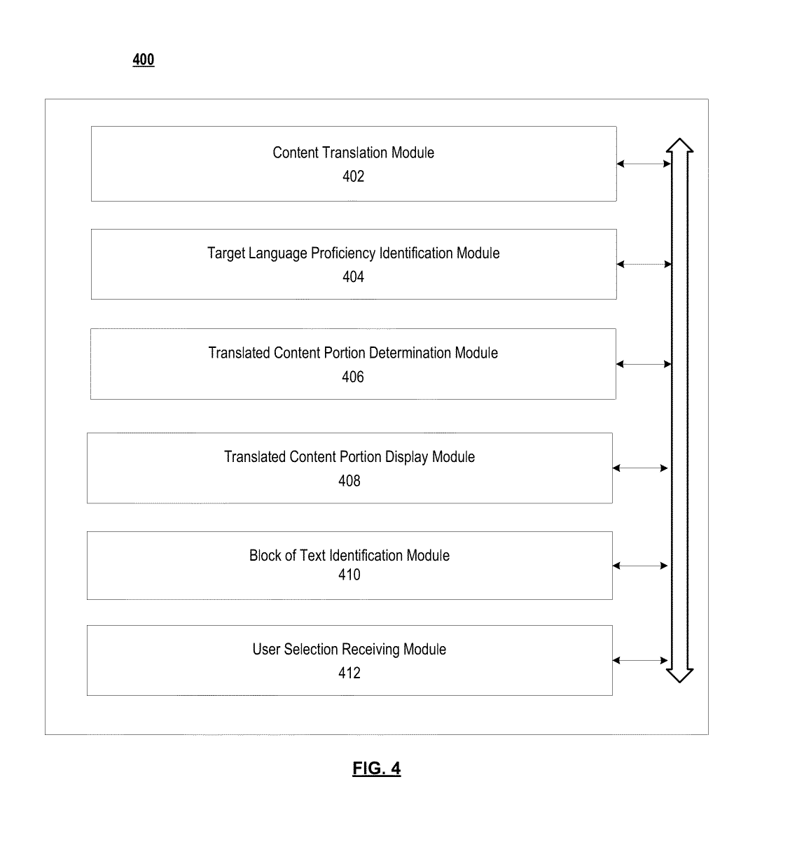

FIG. 4 illustrates an example of system 400 for translating content for learning a language, in accordance with various aspects of the subject technology. System 400 comprises a content translation module 402, a target language proficiency identification module 404, a translated content portion determination module 406, and a translated content portion display module 408. The system may also include a block of text identification module 410 and a user selection receiving module 412.

The content translation module 402 is configured to translate content that is requested by a user, from a source language into a target language. The source language and the target language may be determined based on user selections. The target language proficiency identification module 404 is configured to identify a target language proficiency level of the user. The target language proficiency level may be predetermined based on a user selection.

The translated content portion determination module 406 is configured to determine a portion of the translated content that is translated by the content translation module 402 that corresponds to the target language proficiency level identified by the target language proficiency identification module 404. The translated content portion display module 408 is configured to provide for display the portion of the translated content that is determined to correspond to the target language proficiency level by the translated content portion determination module 406. The determined portion of the translated content may be displayed to the user with the user-requested content such that it appears to the user that select portions of the user-requested content are spontaneously translated into the target language.

The block of text identification module 410 may be configured to identify a block of text from the user-requested content and determine whether a size of the identified block of text exceeds a predetermined threshold. The content translation module 402 may further configured to translate the block of text identified by the block of text identification module 410 if the size of the identified block of text exceeds the predetermined threshold. The user selection receiving module 412 may be configured to receive a user selection on the portion of the translated block of text that is displayed by translated content portion display module 408. The translated content portion display module 408 may be further configured to provide for display the portion selected by the user, in the source language.

These modules may be in communication with one another. In some aspects, the modules may be implemented in software (e.g., subroutines and code). In some aspects, some or all of the modules may be implemented in hardware (e.g., an Application Specific Integrated Circuit (ASIC), a Field Programmable Gate Array (FPGA), a Programmable Logic Device (PLD), a controller, a state machine, gated logic, discrete hardware components, or any other suitable devices) and/or a combination of both. Additional features and functions of these modules according to various aspects of the subject technology are further described in the present disclosure.

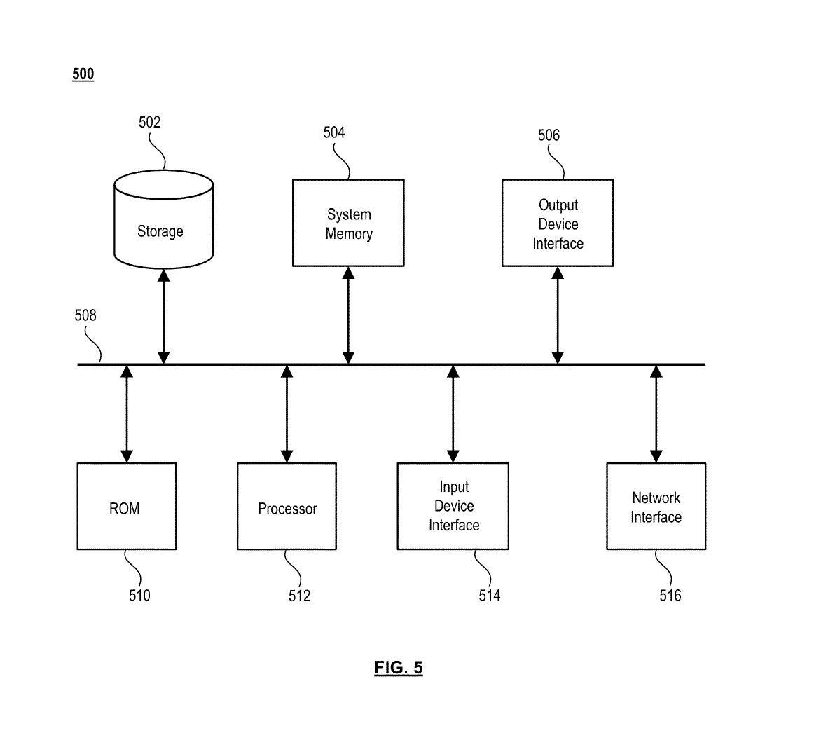

FIG. 5 conceptually illustrates an electronic system with which some aspects of the subject technology are implemented. Electronic system 500 can be a server, computer, phone, PDA, laptop, tablet computer, television with one or more processors embedded therein or coupled thereto, or any other sort of electronic device. Such an electronic system includes various types of computer readable media and interfaces for various other types of computer readable media. Electronic system 500 includes a bus 508, processing unit(s) 512, a system memory 504, a read-only memory (ROM) 510, a permanent storage device 502, an input device interface 514, an output device interface 506, and a network interface 516.

Bus 508 collectively represents all system, peripheral, and chipset buses that communicatively connect the numerous internal devices of electronic system 500. For instance, bus 508 communicatively connects processing unit(s) 512 with ROM 510, system memory 504, and permanent storage device 502.

From these various memory units, processing unit(s) 512 retrieves instructions to execute and data to process in order to execute the processes of the subject disclosure. The processing unit(s) can be a single processor or a multi-core processor in different implementations.

ROM 510 stores static data and instructions that are needed by processing unit(s) 512 and other modules of the electronic system. Permanent storage device 502, on the other hand, is a read-and-write memory device. This device is a non-volatile memory unit that stores instructions and data even when electronic system 500 is off. Some implementations of the subject disclosure use a mass-storage device (such as a magnetic or optical disk and its corresponding disk drive) as permanent storage device 502.

Other implementations use a removable storage device (such as a floppy disk, flash drive, and its corresponding disk drive) as permanent storage device 502. Like permanent storage device 502, system memory 504 is a read-and-write memory device. However, unlike storage device 502, system memory 504 is a volatile read-and-write memory, such a random access memory. System memory 504 stores some of the instructions and data that the processor needs at runtime. In some implementations, the processes of the subject disclosure are stored in system memory 504, permanent storage device 502, and/or ROM 510. From these various memory units, processing unit(s) 512 retrieves instructions to execute and data to process in order to execute the processes of some implementations.

Bus 508 also connects to input and output device interfaces 514 and 506. Input device interface 514 enables the user to communicate information and select commands to the electronic system. Input devices used with input device interface 514 include, for example, alphanumeric keyboards and pointing devices (also called “cursor control devices”). Output device interfaces 506 enables, for example, the display of images generated by the electronic system 500. Output devices used with output device interface 506 include, for example, printers and display devices, such as televisions or other displays with one or more processors coupled thereto or embedded therein, or other appropriate computing devices that can be used for running an application. Some implementations include devices such as a touch screen that functions as both input and output devices.

Finally, as shown in FIG. 5, bus 508 also couples electronic system 500 to a network (not shown) through a network interface 516. In this manner, the computer can be a part of a network of computers (such as a local area network (“LAN”), a wide area network (“WAN”), or an Intranet, or a network of networks, such as the Internet. Any or all components of electronic system 500 can be used in conjunction with the subject disclosure.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD−RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a device having a display device, e.g., televisions or other displays with one or more processors coupled thereto or embedded therein, or other appropriate computing devices that can be used for running an application, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Implementations of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

It is understood that any specific order or hierarchy of steps in the processes disclosed is an illustration of exemplary approaches. Based upon design preferences, it is understood that the specific order or hierarchy of steps in the processes may be rearranged, or that some illustrated steps may not be performed. Some of the steps may be performed simultaneously. For example, in certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A phrase such as a configuration may refer to one or more configurations and vice versa.

The word “example” is used herein to mean “serving as an example or illustration.” Any aspect or design described herein as “example” is not necessarily to be construed as preferred or advantageous over other aspects or designs.

All structural and functional equivalents to the elements of the various aspects described throughout this disclosure that are known or later come to be known to those of ordinary skill in the art are expressly incorporated herein by reference and are intended to be encompassed by the claims.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

1. A computer-implemented method for translating content for learning a language, the method comprising:
determining, by one or more processors, whether a size of an identified block of text of content requested by a user exceeds a predetermined threshold;
automatically translating, by one or more processors, the identified block of text from a source language into a target language if the identified block of text exceeds the predetermined threshold;
automatically translating, by one or more processors, another block of text of the content requested by the user from the source language into the target language if the identified block of text does not exceed the predetermined threshold;
identifying, by one or more processors, a target language proficiency level of the user;
determining, by one or more processors, a portion of the translated block of text that corresponds to the identified target language proficiency level; and
providing for display, on a display of an electronic device, the portion of the translated block of text that is determined to correspond to the target language proficiency level.

2. The method of claim 1, wherein translating the block of text comprises identifying text for translation from the requested content, wherein the identified text is in the source language; and translating the identified text for translation from the source language to the target language.

3. The method of claim 1, wherein the target language proficiency level is identified based on a user selection.

4. The method of claim 1, wherein the portion of the translated block of text that is determined to correspond to the target language proficiency level is provided for display with the requested content.

5. The method of claim 1, further comprising receiving a selection of the displayed portion of the translated block of text from the user, and displaying the selected portion of the translated block of text in the source language.

6. (canceled)

7. The method of claim 1, wherein the target language is determined based on a user selection.

8. The method of claim 1, wherein the portion of the translated block of text that is determined to correspond to the target language proficiency level is displayed within context of the requested content.

9. The method of claim 1, wherein the source language is the user's native language.

10. The method of claim 1, wherein the portion of the translated block of text that corresponds to the identified target language proficiency level is determined based on a predetermined language proficiency scale.

11. A system for translating content for learning a language, comprising:
one or more processors; and
a memory comprising processor-executable instructions, which when executed by the one or more processors cause the system to:
identify a block of text from content requested by a user;
determine whether a size of the identified block of text exceeds a predetermined threshold;
if the size of the identified block of text exceeds the predetermined threshold, automatically translate the identified block of text from a source language into a target language;
if the identified block of text does not exceed the predetermined threshold, automatically translate another block of text of the content requested by the user from the source language into the target language;
identify a target language proficiency level of the user;
determine a portion of the translated block of text that corresponds to the identified target language proficiency level; and
provide for display the portion of the translated block of text that is determined to correspond to the target language proficiency level.

12. The system of claim 11, wherein the target language proficiency level is identified based on a user selection.

13. The system of claim 11, wherein the portion of the translated block of text that is determined to correspond to the target language proficiency level is provided for display with the requested content.

14. The system of claim 11, wherein the target language is determined based on a user selection.

15. The system of claim 11, wherein the portion of the translated block of text that is determined to correspond to the target language proficiency level is displayed within context of the requested content.

16. The system of claim 11, wherein the source language is the user's native language.

17. The system of claim 11, wherein the instructions further cause the system to:
receive a user selection on the displayed portion of the translated block of text; and provide for display the selected portion in the source language.

18. The system of claim 11, wherein the portion of the translated block of text that corresponds to the identified target language proficiency level is determined based on a predetermined language proficiency scale.

19. A non-transitory machine-readable medium comprising instructions stored therein, which when executed by processors, cause the processors to perform operations comprising:
identifying text for translation from content requested by a user, wherein the identified text is in the source language;
automatically translating the identified text for translation from the source language to the target language if a size of the identified text for translation is determined to exceed a predetermined threshold;
automatically translating another block of text of the content requested by the user from the source language into the target language if the identified block of text is determined not to exceed the predetermined threshold;
identifying a target language proficiency level of the user, wherein the target language proficiency level is identified based on a user selection;
determining a portion of the translated text that corresponds to the identified target language proficiency level;
providing for display the portion of the translated text that is determined to correspond to the target language proficiency level with the requested content;
receiving a selection of the displayed portion of the translated text from the user; and
providing for display the selected portion of the translated text in the source language.

20. The non-transitory machine-readable medium of claim 19, wherein the portion of the translated text that corresponds to the identified target language proficiency level is determined based on a predetermined language proficiency scale.

21. (canceled)
